(19) United States
(12) Patent Application Publication
(10) Pub. No.: US 2025/0186295 A1
(43) Pub. Date: Jun. 12, 2025

(54) SYSTEMS AND METHODS FOR THERMOELECTRIC SEQUENTIAL COMPRESSION DEVICES AND INTEGRATED THERMOELECTRIC SEQUENTIAL COMPRESSION DEVICES

(71) Applicant: Hill-Rom Services, Inc., Batesville, IN (US)

(72) Inventors: Robert Mark Zerhusen, Batesville, IN (US); Nicholas A. Mann, Batesville, IN (US)

(73) Assignee: Hill-Rom Services, Inc., Batesville, IN (US)

(21) Appl. No.: 18/969,838

(22) Filed: Dec. 5, 2024

Related U.S. Application Data
(60) Provisional application No. 63/606,832, filed on Dec. 6, 2023.

(51) Int. Cl. A61H 9/00

(52) U.S. Cl. CPC A61H 9/0078; A61H 2201/0103; A61H 2201/0142; A61H 2201/0242; A61H 2201/169; A61H 2201/5007; A61H 2201/5041; A61H 2201/5082; A61H 2205/10

(57) ABSTRACT

A thermoelectric sequential compression device includes a plurality of inflatable bladders arranged in a respective zone of the thermoelectric sequential compression device; a plurality of thermoelectric modules, each of the plurality of thermoelectric modules including a temperature sensor and a foam sheet; and a plurality of channels that are fluidly coupled between the plurality of inflatable bladders and the plurality of thermoelectric modules. A first channel selected from the plurality of channels includes a heat exhaust channel. Each of the plurality of thermoelectric modules are independently controlled to sequentially supply air to a respective inflatable bladder of the respective zone via the plurality of channels.

### CROSS-REFERENCE TO RELATED APPLICATION

This application claims priority to U.S. Provisional Patent Application Ser. No. 63/606,832, filed Dec. 6, 2023, entitled, “SYSTEMS AND METHODS FOR THERMOELECTRIC SEQUENTIAL COMPRESSION DEVICES AND INTEGRATED THERMOELECTRIC SEQUENTIAL COMPRESSION DEVICES,” the entirety of which is incorporated by reference herein.

### FIELD

The present disclosure generally relates to devices for managing circulation, and more particularly, to sequential compression devices.

### BACKGROUND

Compression devices play an integral role in the well-being of subjects. The compression devices can assist with circulation in extremities (e.g., the legs), decreasing the likelihood of various issues, such as, for example, deep vein thrombosis (DVT). Many facilities have protocols that mandate use of the compression devices unless indicated otherwise. However, subjects that wear compression devices often find them progressively uncomfortable. This can be due to the fabric of the compression device not breathing correctly because the compression device itself should be airtight allowing for inflation. In addition, the compression device is generally tight fitting so that the extremities of the subject benefit from the compression. In addition, extended operation of components causes the air that circulates within the compression device to increase in temperature, thereby heating the compression device itself. As a result, the compression device causes discomfort (e.g., the subject feels hot and uncomfortable, the subject sweats, the subject feels itchy or the like).

### BRIEF DESCRIPTION OF THE DRAWINGS

In one aspect, a thermoelectric sequential compression device may include a plurality of inflatable bladders arranged in a respective zone of the thermoelectric sequential compression device. The thermoelectric sequential compression device may include a plurality of thermoelectric modules. Each of the plurality of thermoelectric modules may include a temperature sensor and a foam sheet. The thermoelectric sequential compression device may include a plurality of channels that are fluidly coupled between the plurality of inflatable bladders and the plurality of thermoelectric modules. A first channel selected from the plurality of channels may include a heat exhaust channel. Each of the plurality of thermoelectric modules may be independently controlled to sequentially supply air to a respective inflatable bladder of the respective zone via the plurality of channels.

In another aspect, an integrated bed system may include a platform including a processor and a non-transitory, processor readable storage medium communicatively coupled to the processor, the non-transitory, processor readable storage medium including one or more instructions stored thereon. The integrated bed system may include a thermoelectric sequential compression device that is communicatively coupled to the platform. The thermoelectric sequential compression device may include a plurality of inflatable bladders arranged in a respective zone of the thermoelectric sequential compression device. The thermoelectric sequential compression device may include a plurality of thermoelectric modules each including a temperature sensor layer and a foam sheet. The thermoelectric sequential compression device may include a plurality of channels that are fluidly coupled between the plurality of inflatable bladders and the plurality of thermoelectric modules. A first channel selected from the plurality of channels may include a heat exhaust channel. The one or more instructions, when executed, may cause the processor to independently control each of the plurality of thermoelectric modules to sequentially supply air to a respective inflatable bladder of the respective zone via the plurality of channels.

In another aspect, a non-transitory, computer-readable medium including instructions that, when executed by at least one processor, cause the at least one processor to perform one or more operations including independently controlling each of a plurality of thermoelectric modules of a thermoelectric sequential compression device to sequentially supply air to a respective inflatable bladder of a respective zone of the thermoelectric sequential compression device via a plurality of channels of the thermoelectric sequential compression device. The respective inflatable bladder may be one of a plurality of inflatable bladders arranged in the respective zone of the thermoelectric sequential compression device. The plurality of thermoelectric modules may each include a temperature sensor and a foam sheet. The plurality of channels may be fluidly coupled between the plurality of inflatable bladders and the plurality of thermoelectric modules. A first channel selected from the plurality of channels may include a heat exhaust channel.

In another aspect, a method may include independently controlling a thermoelectric module of a thermoelectric sequential compression device to sequentially supply air to a respective inflatable bladder. The method may include controlling a blower to supply a first predetermined amount of air at a first predetermined temperature value to a first inflatable bladder, and supply a second predetermined amount of air at a second predetermined temperature value to a second inflatable bladder. The method may include controlling a fan to exhaust the air from a heat exhaust channel of the thermoelectric sequential compression device. The method may include restricting, via a user interface, the first and second predetermined temperature values and pressure control of hot air and cold air supplied to the first and second inflatable bladders based on a subject type.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

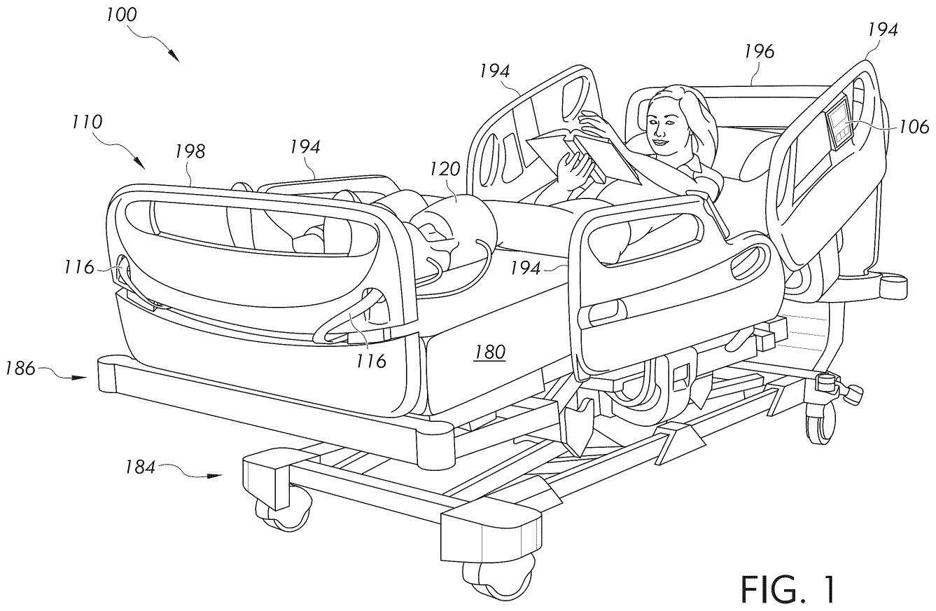

FIG. 1 depicts a schematic diagram of an example integrated bed system including compression devices, according to one or more embodiments shown and described herein;

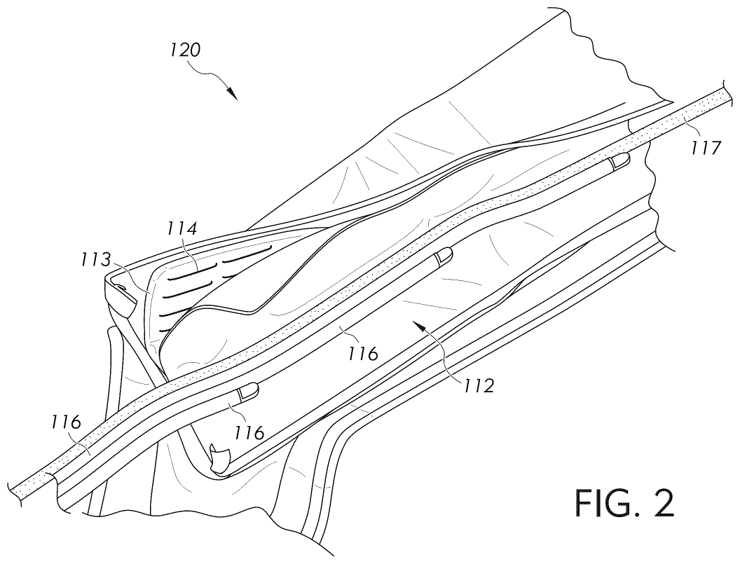

FIG. 2 depicts a perspective view of an example thermoelectric sequential compression device, according to one or more embodiments shown and described herein;

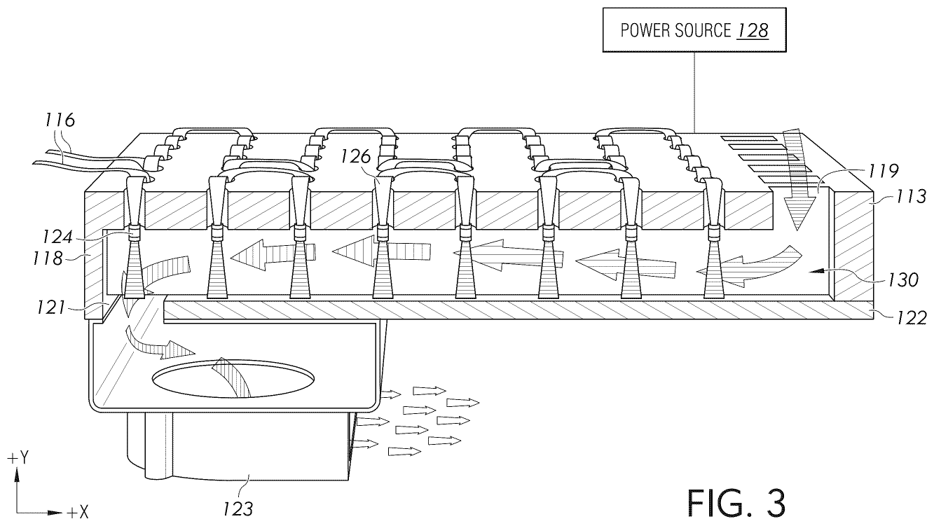

FIG. 3 depicts a cross-sectional view of a portion of the thermoelectric sequential compression device of FIG. 2, according to one or more embodiments shown and described herein;

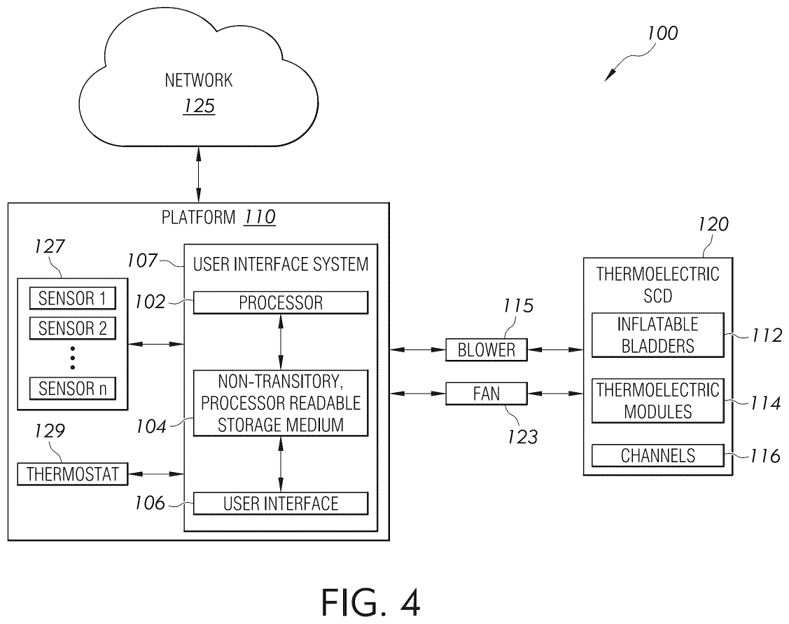

FIG. 4 depicts a block diagram of various example components of the integrated bed system of FIG. 1, according to one or more embodiments shown and described herein;

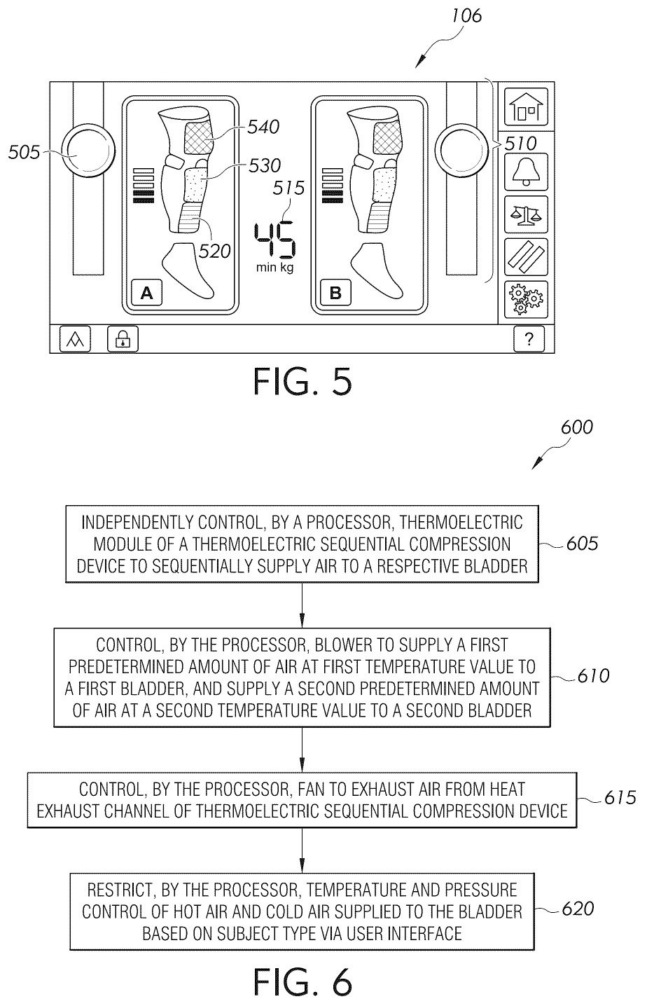

FIG. 5 depicts a schematic diagram of an example user interface, according to one or more embodiments shown and described herein; and

FIG. 6 depicts a flow diagram of an example method to be performed by a processor, according to one or more embodiments shown and described herein.

### DETAILED DESCRIPTION

The present disclosure relates to systems and methods for thermoelectric sequential compression devices utilizing thermoelectric technology to compensate for excessive heat generated while a subject wears the thermoelectric sequential compression device. Thermoelectric foam modules are incorporated in the thermoelectric sequential compression device fabric and inflatable bladder construction, and are configured to provide heating and cooling, thus delivering enhanced subject comfort. Moreover, the thermoelectric foam modules include temperature sensors allowing for optimal temperatures to be maintained, reducing the likelihood of pressure injuries. A plurality of thermoelectric foam modules may be included for zonal heating and cooling, one per inflatable bladder of the thermoelectric sequential compression device. In other aspects, a single thermoelectric foam module may be included in the thermoelectric sequential compression device for heating or cooling. By independently, and in some aspects remotely, controlling the temperature and pressure amount of hot air and cold air supplied to any number of inflatable bladders via a user interface, monitoring and operational efficiency of the thermoelectric sequential compression device is improved and achieved in real-time. For example, a blower may be directed to provide any number of inflatable bladders with air in a sequential fashion, promoting efficient blood circulation. Unlike conventional compression devices, the thermoelectric sequential compression devices disclosed herein can be integrated with a platform where the subject does not need to sit towards the end of a bed or require a separate over-the-bed table. Because control of the temperature and pressure amount of the hot and cold air is not unrestricted, security and access permissions are particularly customized and implemented via the user interface based on a user type for thermoelectric sequential compression device operation control, including controlled administration of a therapeutic temperature and pressure operation control.

While the present disclosure relates specifically to medical surgical rooms including subject monitors and hospital beds, it should be understood that this is merely an example. That is, the systems and methods described herein may be used for any type of medical equipment, either within the medical surgical rooms or outside the medical surgical rooms, that is configured to provide power and/or control of sequential compression devices, including, but not limited to, overhead lifts, vital monitoring equipment, control devices, wall-mounted displays, nurses station equipment, surgical equipment, furniture, wheelchairs, and the like.

FIG. 1 depicts a schematic diagram of an example integrated bed system 100. As illustrated in FIG. 1, the integrated bed system 100 includes a platform 110 and a thermoelectric sequential compression device 120. The platform 110 may include a user interface 106. The thermoelectric sequential compression device 120 may include a plurality of channels 116. Although FIG. 1 illustrates single instances of the constituent components of the integrated bed system 100, the integrated bed system 100 may include any number of constituent components.

The platform 110 may include a bed 180, such as a hospital bed, configured to support a subject as further described below with respect to FIG. 4. In certain aspects, the bed 180 includes a base frame 184 coupled to an upper frame 186. The upper frame 186 is adjustable relative to the base frame 184 (e.g., raise, lower, tilt, etc.). Additionally, the upper frame 186 may include a plurality of segments that are independently adjustable relative to one another, allowing the upper frame 186 to articulate between various positions (e.g., an elevated head region, elevated foot region, etc.). The bed 180 includes actuation assemblies for adjusting the upper frame 186 and the plurality of segments. The bed 180 also includes side rails 194, which are adjustable between a raised position and a lowered position. Further, the bed 180 includes a headboard 196 and a footboard 198, which may be fixedly coupled to the upper frame 186 or removable to provide increased access to the subject. It is understood that that platform 110 may include other types of beds.

The user interface 106 may include a display that is communicatively coupled to a processor, such as a processor 102 of platform 110 as further described below with respect to FIGS. 4 and 5. As explained below with respect to FIG. 4, and in certain aspects, the user interface 106 may be a part of a user interface system 107 of the platform 110 or alternatively a stand-alone device that is not the platform 110. The user interface 106 may be located on any portion of a side rail 194.

The thermoelectric sequential compression device 120 may include a plurality of channels 116. The plurality of channels 116 may be fluidly coupled between a plurality of inflatable bladders, such as plurality of inflatable bladders 112, and the plurality of thermoelectric modules, such as plurality of thermoelectric modules 114, as further described below with respect to thermoelectric sequential compression device 120 of FIG. 4. In certain aspects, the plurality of channels 116 may pass through an aperture of the footboard 198.

The thermoelectric sequential compression device 120 may be communicatively coupled to the platform 110. In certain aspects, the thermoelectric sequential compression device 120 may be communicatively coupled to a processor 102 of the platform 110 via a blower 115, a fan 123, and/or the like, as further described below with respect to FIG. 4.

FIG. 2 depicts a perspective view of an example thermoelectric sequential compression device 120. The thermoelectric sequential compression device 120 includes an inflatable bladder 112, a foam sheet 113, a thermoelectric module 114, and a plurality of channels 116. At least one of the plurality of channels 116 may include a heat exhaust channel 117. Although FIG. 2 illustrates single instances of the constituent components of the thermoelectric sequential compression device 120, the thermoelectric sequential compression device 120 may include any number of constituent components. FIG. 2 may reference any and all components as previously described above with respect to FIG. 1 or any other figure.

In certain aspects, the inflatable bladder 112 may include one of a plurality of inflatable bladders. In other aspects, the inflatable bladder 112 may include two or more inflatable bladders. The inflatable bladder 112 may be supplied with air so as to controllably inflate the inflatable bladder 112 to a predetermined pressure value at a predetermined temperature value. In certain aspects, the inflatable bladder 112 may be supplied with hot air and cold air from a blower, such as a blower 115, via the plurality of channels 116. As will be discussed below with respect to FIGS. 4-6, the processor 102 may be configured to direct, such as via a user interface 106, the blower 115 to supply hot air and cold air to the inflatable bladder 112 via the plurality of channels.

As will we discussed below with respect to FIGS. 3-4, the heat exhaust channel 117 of the plurality of channels 116 may be configured to exhaust the hot air under a cooling mode operation. In addition, as explained below with respect to FIG. 3, the thermoelectric module 114 may include a foam sheet 113 that is configured to condition air that is supplied to the plurality of channels 116 due to the Peltier effect. The thermoelectric sequential compression device 120 may further include material, such as waterproof fabric material, that is configured to allow for temperature fluctuation of thermoelectric heating and cooling of the respective inflatable bladder 112 of a respective zone via the plurality of channels 116, as will be described below. In certain aspects, the plurality of channels 116 may include similar or different dimensions, such as widths, lengths, and the like. In certain aspects, the thermoelectric sequential compression device 120 may include a reusable thermoelectric sequential compression device. In other aspects, the thermoelectric sequential compression device 120 may include a disposable thermoelectric sequential compression device.

FIG. 3 depicts a cross-sectional view of a portion of the thermoelectric sequential compression device 120. The portion of the thermoelectric sequential compression device 120 includes a foam sheet 113, a plurality of channels 116, an inlet 119, and an outlet 121. The thermoelectric sequential compression device 120 may be communicatively coupled to a fan 123. Although FIG. 3 illustrates single instances of the constituent components of the thermoelectric sequential compression device 120, the thermoelectric sequential compression device 120 may include any number of constituent components. FIG. 3 may reference any and all components as previously described above with respect to FIGS. 1-2 or any other figure.

The foam sheet 113 may include a plurality of layers, such as a first layer 118 and a second layer 122. As depicted in FIG. 3, and in certain aspects, the first layer 118 may be disposed above the second layer 122, such as relative to a +Y direction of the coordinate axes of FIG. 3. In certain aspects, the first layer 118 may include a lower density value than that of the second layer 122. The second layer 122 may be configured to include, as compared to the first layer 118, denser non-permeable foam to create and support the plurality of channels 116 with channel walls that avoid collapse under pressure. In certain aspects, and without limitation, an indentation load deflection for the first layer 118 may range between about 12 to 27, such as between about 15 to 24, and an indentation load deflection for the second layer 122 between about 30-93, such as between about 33-90. Thermoelectric cooler junctions 124 may be positioned between the two layers, here between the first layer 118 and the second layer 122, and braided-wire connectors 126 to create a thermal interface with the subject on top and with moving air underneath. In some aspects, the plurality of thermoelectric modules 114 may each include a plurality of coils. A temperature difference, due to the Peltier effect, between ends of each coil, may be generated by heat transfer such that current running in one direction across the coil achieves a warming effect, and reversing current in an opposite direction achieves a cooling effect. In certain aspects, a power source 128 may be connected to the plurality of thermoelectric modules 114, and supply the current to a closed loop defined by the ends of each coil. The power source 128 may be controlled by a processor, such as the processor 102, to supply the current.

The plurality of channels 116 may be disposed through the foam sheet 113. In certain aspects, each of the plurality of channels 116 may be disposed through each of the first layer 118 and the second layer 122 (e.g., disposed in the +Y direction of the coordinate axes of FIG. 3). The inlet 119 may be formed in a wall of the second layer 122 relative to the Y-axis direction. The inlet 119 may include any shape and/or size. A passage 130 of the second layer 122 may be disposed in the X-axis direction of the coordinate axes of FIG. 3, and partially define a portion of the inlet 119. The inlet 119 may supply air to the outlet 121 through the passage 130.

The outlet 121 may be formed in a wall opposite to that of the first of the inlet 119, and relative to the Y-axis direction of the coordinate axes of FIG. 3. The outlet 121 may include any shape and/or size. The outlet 121 may be similar or different to the shape and/or size of the inlet 119 (e.g., correspond to the shape and/or size of the inlet 119). The outlet 121 may be located at an opposite end of the inlet 119, and disposed below the inlet 119 relative to the Y-axis direction of the coordinate axes of FIG. 3. In certain aspects, the passage 130 may define both the inlet 119 and the outlet 121 through which cool air is supplied via the inlet 119 and passed through the outlet 121 as hot air relative to the X-axis direction of the coordinate axes of FIG. 3.

Ingress of air supplied by a blower 115 may enter via the inlet 119, such as an air inlet, of the foam sheet 113, which traverses (as indicated by the arrows and direction of flow relative to the +X axis direction of the coordinate axes of FIG. 3) through the foam sheet 113 and exits via the outlet 121, such as an air outlet. For example, a fan 123 may be communicatively coupled to the outlet 121, which is configured to exhaust hot air during a cooling mode operation. In certain aspects, at least one of the plurality of channels 116, such as the heat exhaust channel 117, is used for thermoelectric cooling by exhausting heated air from a passage, such as the passage 130, out via the outlet 121. The cooling mode operation of the thermoelectric sequential compression device 120 may include exhausting of the hot air to promote optimal cooling.

FIG. 4 depicts a block diagram of various example components of the integrated bed system 100. The integrated bed system 100 includes the platform 110, the blower 115, the fan 123, the thermoelectric sequential compression device 120, and a network 125. Although FIG. 4 illustrates single instances of the constituent components of the integrated bed system 100, the integrated bed system 100 may include any number of constituent components. FIG. 4 may reference any and all components as previously described above with respect to FIGS. 1-3 or any other figure.

The platform 110 may include a user interface system 107, one or more sensors 127, and a thermostat 129. The user interface system 107 may include a processor 102, a non-transitory processor readable storage medium 104, and a user interface 106. The processor 102, such as a central processing unit (CPU), may be the central processing unit that is configured to perform calculations and logic operations to execute one or more programs. The processor 102, alone or in conjunction with the other components, may be an illustrative processing device, computing device, processor, or combinations thereof, including, for example, a multi-core processor, a microcontroller, a field-programmable gate array (FPGA), or an application-specific integrated circuit (ASIC). The processor 102 may include any processing component configured to receive and execute instructions (such as from the non-transitory, processor readable storage medium 104). In some embodiments, the processor 102 may include a plurality of processing devices.

The non-transitory, processor readable storage medium 104 may contain one or more data repositories for storing data that is received and/or generated. The non-transitory, processor readable storage medium 104 may be any physical storage medium, including, but not limited to, a hard disk drive (HDD), memory (e.g., read-only memory (ROM), programmable read-only memory (PROM), random access memory (RAM), double data rate (DDR) RAM, flash memory, and/or the like), removable storage, a configuration file (e.g., text) and/or the like. While the non-transitory, processor readable storage medium 104 is depicted as a local device, it should be understood that the non-transitory, processor readable storage medium 104 may be a remote storage device, such as, for example, a server computing device, cloud-based storage device, or the like.

The user interface system 107 may include any number and combination of constituent hardware components, such as, for example, a display, a keyboard, a mouse, and/or the like. In certain aspects, the display may be a touchscreen. In other aspects, the display may not be a touchscreen. In certain aspects, the keyboard may include a virtual keyboard. In other aspects, the keyboard may include a physical keyboard. In certain aspects, the mouse may include a virtual mouse. In other aspects, the mouse may include a physical mouse. The constituent hardware components may be communicatively coupled to the user interface 106 to provide input thereto. The input received at the user interface 106, via the constituent hardware components, may be displayed on the display. It is understood that the user interface system 107 may include any other types of I/O devices and/or I/O communication interfaces for controlling operations of the user interface 106 to provide additional functionality and configuration options, and/or control display characteristics of the user interface 106. The operations of the user interface 106 will be described in further detail with respect to FIG. 5.

In certain aspects, the user interface 106 may be a part of a device (not shown), such as a stand-alone device other than the platform 110. In other aspects, the user interface 106 may be a part of the platform 110. In certain aspects, the user interface 106 may be accessed by the subject using a remote control, a tablet, a smart phone, a laptop, a desktop, a server, etc., which may or may not be provided by a facility in which the integrated bed system 100 is located (e.g., a hospital). For example, a subject and/or a user may download and execute an application onto their mobile device to access and interact with the user interface 106. As referred to herein, and by way of example, the subject may include the individual that wears the thermoelectric sequential compression device 120. As referred to herein, and by way of example, the user may include an individual that is not a subject, such as a nurse practitioner, a physician, a medical assistant, a physician trainee, a caregiver, or the like. In other aspects, the user interface 106 may be accessed by a facility-supplied device or a third-party supplied device that includes the application for execution and subsequent interaction with the user interface 106. Alternatively, the platform 110 may include the user interface 106 that is accessible by the subject and/or the user. In certain aspects, such as the stand-alone device including the user interface 106 or of the platform 110 including the user interface 106, may be configured to communicate via the network 125 to control the thermoelectric sequential compression device 120. In certain aspects, the stand-alone device including the user interface 106 or the platform 110 including the user interface 106 and/or a switch interface, including but not limited to a physical switch interface that include any number buttons, switches, tabs, or other switch interface constituent components that allow for control, may be configured to communicate via the network 125 to control the thermoelectric sequential compression device 120. In certain aspects, the physical switch interface may be connected to a power outlet. In other aspects, the physical switch interface may include its own power source, separate or shared, with the platform 110 and/or the stand-alone device. In certain aspects, the processor 102 may be configured to establish communication and connect to a server (not shown) via the network 125 and/or database of an entity, such as a server and/or a database of a facility, including but not limited to, an electronic medical record (EMR) system of a hospital. In this manner, the EMR system may be configured to, without limitation, store and update a log of timings and applications of temperature and/or pressure as controlled by the processor 102, update EMR data pertaining to sensed information, and/or the like as disclosed herein.

In some aspects, the blower 115 may include a stand-alone blower or an integrated blower that is communicatively coupled to the processor 102. For example, the stand-alone blower may not be part of the platform 110, and is configured to be directed by the processor 102 to supply air to an inflatable bladder 112 via the plurality of channels 116 at a predetermined temperature and/or a predetermined pressure amount. In addition, the stand-alone blower includes an integrated power supply and/or electronic component(s) that are independent from that of the platform 110, as described herein. In some aspects, the air supplied by the stand-alone blower may be controlled by a remote control that includes the processor 102. A remote control device may include the processor 102, and controls the amount of air supplied by the stand-alone blower. In this manner, the platform 110 does not need to include the processor 102. The remote control device may be controlled by the user. In other aspects, the remote control device may include a server that includes the processor 102, and controls the amount of air supplied by the stand-alone blower.

In other aspects, the blower 115 may be an integrated blower within the platform 110. For example, the blower may be communicatively coupled to the platform 110 and the processor 102, and is configured to be directed by the processor 102 to supply air to an inflatable bladder 112 via the plurality of channels 116 at a given temperature and/or a given pressure amount. In addition, the blower may be configured to share a power supply of the platform 110. In certain aspects, the air supplied by the blower may be controlled by the processor 102 of the platform 110. Without limitation, and with reference to FIG. 4, the blower and/or constituent electronic components, such as the actuation assemblies, of the platform 110, may be located within any portion of the platform 110, such as the side rails 194, headboard 196, the base frame 184, the upper frame 186, footboard 198, underneath the platform 110, etc. In certain aspects, platform 110 may include its own power source. In other aspects, the platform 110 may be connected to a wall outlet, that is shared or different from the power outlet of the physical switch interface previously described above.

The blower 115 may be communicatively coupled to the thermostat 129, which is configured to regulate a temperature of the air supplied to the respective inflatable bladder 112 of the respective zone via the plurality of channels 116.

The network 125 may be one or more of a wireless network, a wired network, or any combination of wireless network and wired network, and may be configured to operably communicate with any and all of the constituent components of the integrated bed system 100. For example, network 125 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 125 may include, without limitation, telephone lines, fiber optics, IEEE Ethernet 802.3, a wide area network, a wireless personal area network, a LAN, or a global network such as the Internet. In addition, the network 125 may support an Internet network, a wireless communication network, a cellular network, or the like, or any combination thereof. The network 125 may further include one network, or any number of the exemplary types of networks mentioned above, operating as a stand-alone network or in cooperation with each other. The network 125 may utilize one or more protocols of one or more network elements to which they are communicatively coupled. The network 125 may translate to or from other protocols to one or more protocols of network devices. Although the network 125 is depicted as a single network, it should be appreciated that in one or more aspects, the network 125 may include a plurality of interconnected networks, such as, for example, the Internet, a service provider's network, a cable television network, corporate networks, such as credit card association networks, and home networks.

For example, the platform 110 may include the one or more sensors 127 configured to measure one or more biometric parameters of a subject. Without limitation, the one or more biometric parameters measured by the one or more sensors 127 may include a respective value associated with a respiratory rate, a heart rate, blood oxygen saturation level (SpO₂), a body temperature, a heart rate variability, or any combination thereof, and the like. In certain aspects, the processor 102 may be configured to react to one or more biometric parameters obtained by the platform 110. In response to the one or more biometric parameters, the processor 102 may be configured to adjust temperature and/or pressure settings. In one example, responsive to a first biometric parameter, such as a heart rate, and a second biometric parameter, such as a respiratory rate, obtained by a respective sensor of the platform 110, the processor 102 may be configured to control the amount of air supplied by the blower 115 to the inflatable bladder 112 via the plurality of channels 116. In another example, responsive to a first biometric parameter, such as a temperature, obtained by a respective sensor of the platform 110, the processor 102 may be configured to control the temperature supplied to the inflatable bladder 112 via the plurality of thermoelectric modules 114. In this manner, the processor 102 may be configured to control an amount of a predetermined temperature value or range and/or a predetermined pressure value or range in response to one or more biometric parameters. In certain embodiments, it is understood that all of the one or more sensors 127 need not be part of the platform 110, that the platform 110 may include only a predetermined number and/or a type of the one or more sensors 127, and that any of the one or more sensors 127 may be, for example, stand-alone sensors.

In certain aspects, the processor 102 may be configured to control the amount of a predetermined temperature value or range supplied to one or more surfaces including a designated area of the subject. For example, the processor 102 may be configured to control the amount of a predetermined temperature value supplied by the thermoelectric sequential compression device 120 via the plurality of thermoelectric modules 114 to cool the designated area of the skin of the subject to prevent or inhibit the development of a skin ulcer upon sensing a skin spot indicative of the ulcer as sensed by the one or more sensors 127 of the platform 110 or the thermoelectric sequential compression device 120.

In certain aspects, the thermostat 129 may regulate the air temperature supplied to an inflatable bladder 112 via the processor 102. In certain aspects, the user interface 106 may be communicatively coupled to a thermostat 129 of the platform 110, in which the air temperature supplied to the inflatable bladder 112 may be increased, decreased, or maintained at a predetermined set temperature. The thermostat 129, in certain aspects, may be controlled via selection and/or input of one or more buttons on the user interface 106.

FIG. 5 depicts a schematic diagram of an example user interface 106. The user interface 106 may include a predetermined temperature range control 505, a predetermined temperature range 510, a pressure amount 515, a first zone 520, a second zone 530, and a third zone 540. Although FIG. 5 illustrates single instances of the constituent components of the user interface 106, the user interface 106 may include any number of constituent components. FIG. 5 may reference any and all components as previously described above with respect to FIGS. 1-4 or any other figure.

Each of the plurality of thermoelectric modules 114 may be controlled to sequentially supply air to a respective inflatable bladder 112 of the respective zone via the plurality of channels 116. In certain aspects, each of the plurality of thermoelectric modules 114 may be independently controlled by a processor, such as the processor 102, to sequentially supply and maintain hot air and cold air in accordance with respective predetermined threshold values for temperature control and/or pressure control. For example, each of the plurality of thermoelectric modules 114 may be independently controlled by a user interface 106, which is communicatively coupled to the processor 102, to sequentially supply and maintain the hot air and cold air in accordance with respective predetermined threshold values. In certain aspects, each of the plurality of thermoelectric modules 114 may be controlled by the processor 102 via the user interface 106 of the user interface system 107, to supply air (as a predetermined temperature and/or predetermined pressure) to a particular body portion of the subject, as described below.

The user interface 106 may include a display that includes the predetermined temperature range control 505, the predetermined temperature range 510, and the pressure amount 515 for both right and left leg portions of a subject. In addition, the display may include the first zone 520, the second zone 530, and the third zone 540 for both right and left leg portions of the subject. By way of example, the pressure amount available for input selection, via the user interface 106, may include a “HIGH” setting, a “MEDIUM” setting, and a “LOW” setting. Alternatively and/or additionally, any pressure amount may be input via the user interface 106.

The predetermined temperature range control 505 may include a button that is configured to slide to an upper value and a lower value via the user interface 106. Upon sliding of the button, by the subject via the user interface 106, to a value within the predetermined temperature range 510, the processor 102 may be configured to set a value of the temperature supplied to a desired inflatable bladder 112. By way of example, the processor 102 may be configured to direct the blower 115 to supply a first predetermined amount of hot air at a first temperature value to a first inflatable bladder 112 of the first zone 520, direct the blower 115 to supply a second predetermined amount of cold air at a second temperature value to a second inflatable bladder 112 of the second zone 530, and direct the blower 115 to supply a third predetermined amount of cold air at a third temperature value to a third inflatable bladder 112 of the third zone 540.

In certain aspects, a first inflatable bladder 112 is arranged in a first zone 520, a second inflatable bladder 112 is arranged in a second zone 530, and a third inflatable bladder 112 is arranged in a third zone 540. Each of the first zone 520, the second zone 530, and the third zone 540 are positioned adjacent to leg portions of the subject. Without limitation, the first zone 520 may be positioned below the second zone 530, which is positioned below the third zone 540 at respective different leg portions, right and/or left, of the subject. In certain aspects, the button that is configured to slide to any value for a predetermined temperature value and/or a predetermined pressure value via the user interface 106 may correspond to a particular leg portion of the subject only. In other aspects, the button that is configured to slide to any value for the predetermined temperature value and/or a predetermined pressure value via the user interface 106 may correspond to different body portions of the subject, i.e. that is, not only corresponding to a single body portion of the subject.

It should be understood that the sequence of supplying, by the blower 115 at the direction of the processor 102, the hot air or the cold air to a particular inflatable bladder 112 of the thermoelectric sequential compression device 120 is not limited to the above example, and that any sequence of supplying the hot air or the cold air to a given inflatable bladder 112 in a given zone may be achieved via the user interface 106. For example, in one sequence, a first inflatable bladder 112 may be first supplied with air at a first temperature value and a first pressure amount, next followed by a second inflatable bladder 112 supplied with air at a second temperature value and a second pressure amount, and then a third inflatable bladder 112 supplied with air at a third temperature value and a third pressure amount. Alternative sequences are also within the scope, such as the second inflatable bladder 112 being first supplied with air at a given temperature value and a given pressure amount, or the third inflatable bladder 112 being first supplied with air at a given temperature value and a given pressure amount.

It should be understood that the input of the value of the temperature and the value of the pressure amount by the subject and/or a user is not limited to slide input via the user interface 106. Other types of input may be provided by the subject and/or the user via the user interface 106, including but not limited to audio input of the temperature value and the pressure amount value, manual input of the temperature value and the pressure amount value, or any combination thereof.

The user interface 106 may be configured to restrict temperature control of the hot air and cold air for a first predetermined temperature range input by a subject. For example, the thermoelectric sequential compression device 120 may be worn by the subject. It is further understood that the thermoelectric sequential compression device 120 is not limited to leg portions of a subject, and that other body portions of the subject may wear the thermoelectric sequential compression device 120, such as waist and arm portions of the subject. The first predetermined temperature range includes a therapeutic range. The therapeutic range may be preconfigured to allow temperature control for the hot air and the cold air to be automatically administered to the subject without any oversight or intervention. In certain aspects, the therapeutic range may not be modified by the subject.

Further, the user interface 106 may be configured to restrict temperature control of the hot air and cold air for a second predetermined temperature range input by a user, which may or may not be the subject. As referred to herein, and without limitation, the user may include an individual that is not a subject, such as a nurse practitioner, a physician, a medical assistant, a physician trainee, a caregiver, or the like. In certain aspects, the user interface 106 may or may not be intended to be used or not be used by the subject and/or the user. The second predetermined temperature range includes a temperature range that is greater than the first predetermined temperature range. The user interface 106 may be configured to allow the user to input a greater and/or a lower temperature control of the hot air and the cold air than that which is included within the therapeutic range. In this manner, the user may be configured to override, via the user interface 106, the temperature control that is set or input by the subject. In other aspects, the user may be configured to modify, via the user interface 106, permissions to the first predetermined temperature range input by the subject. For example, the user may be configured to revoke, via the user interface 106, the first predetermined temperature range input by the subject via the user interface 106. In other aspects, the user may be configured to allow, via the user interface 106, the first predetermined temperature range to be input by the subject via the user interface 106.

Additionally or alternatively to restricting temperature control, the user interface 106 may be configured to restrict pressure control of the hot air and cold air for a first predetermined pressure range input by the subject. The first predetermined pressure range includes a therapeutic range. The therapeutic range may be preconfigured to allow pressure control for the hot air and the cold air to be automatically administered to the thermoelectric sequential compression device 120 worn by the subject without any oversight or intervention. In certain aspects, the therapeutic range may not be modified by the subject.

Further, the user interface 106 may be configured to restrict pressure control of the hot air and cold air for a second predetermined pressure range input by the user. The second predetermined pressure range includes a pressure range that is greater than the first predetermined pressure range. The user interface 106 may be configured to allow the user to provide a greater and/or a lower pressure control of the hot air and the cold air than that which is included within the therapeutic range. In this manner, the user may be configured to override, via the user interface 106, the pressure control that is input by the subject. In other aspects, the user may be configured to modify, via the user interface 106, permissions to the first predetermined pressure range input by the subject. For example, the user may be configured to revoke, via the user interface 106, the first predetermined pressure range input by the subject via the user interface 106. In other aspects, the user may be configured to allow, via the user interface 106, the first predetermined pressure range to be input by the subject via the user interface 106.

FIG. 6 depicts a flow diagram of an example method 700 performed by the processor 102. FIG. 6 may reference and incorporate any of the above constituent components and corresponding disclosure explained above with respect to FIGS. 1-5, such as the example integrated bed system including compression device of FIG. 1, the example thermoelectric sequential compression device of FIG. 2, the portion of the thermoelectric sequential compression device of FIG. 3, the example components of the integrated bed system of FIG. 4, and the example user interface of FIG. 5.

At block 605, the processor 102 independently controls a thermoelectric module 114 of a thermoelectric sequential compression device 120 to sequentially supply air to a respective inflatable bladder 112. The thermoelectric sequential compression device 120 may include a plurality of channels 116. The plurality of channels 116 may be fluidly coupled between a plurality of inflatable bladders 112 and a plurality of thermoelectric modules. The thermoelectric sequential compression device 120 may be communicatively coupled to the processor 102.

In certain aspects, the inflatable bladder 112 may comprise one of a plurality of inflatable bladders 112. The inflatable bladder 112 may be supplied with air so as to controllably inflate the inflatable bladder 112 to a predetermined pressure value at a predetermined temperature value. For example, the inflatable bladder 112 may be supplied with hot air and cold air from a blower, such as a blower 115, via the plurality of channels 116. The processor 102 may be configured to direct, such as via a user interface 106, the blower 115 to supply hot air and cold air to the inflatable bladder 112 via the plurality of channels 116.

At block 610, the processor 102 controls a blower 115 to supply a first predetermined amount of air at a first temperature value to a first inflatable bladder 112, and supply a second predetermined amount of air at a second temperature value to a second inflatable bladder 112.

At block 615, the processor 102 controls a fan 123 to exhaust air from a heat exhaust channel 117 of the thermoelectric sequential compression device 120. The heat exhaust channel 117 of the plurality of channels 116 may be configured to exhaust the hot air under a cooling mode operation. In addition, the thermoelectric module 114 may include a foam sheet 113 that is configured to condition air that is supplied to the plurality of channels 116. The thermoelectric sequential compression device 120 may be communicatively coupled to a fan 123.

At block 620, the processor 102 restricts, via a user interface 106, temperature and pressure control of hot air and cold air supplied to the respective inflatable bladder 112 based on a subject type. For example, depending on whether the subject type is a subject that is providing input, via the user interface, or whether the subject type is a user that is providing the input, via the user interface, such as the user interface 106, certain access and permissions may be controlled so as to input the temperature and pressure control of hot air and cold air supplied to a given inflatable bladder 112 via the blower 115.

The present disclosure relates to systems and methods for thermoelectric sequential compression devices utilizing thermoelectric technology to compensate for excessive heat generated while a subject wears the thermoelectric sequential compression device. Thermoelectric foam modules are incorporated in the thermoelectric sequential compression device fabric and inflatable bladder construction, and are configured to provide heating and cooling, thus delivering enhanced subject comfort. Moreover, the thermoelectric foam modules include temperature sensors allowing for optimal temperatures to be maintained, reducing the likelihood of pressure injuries. A plurality of thermoelectric foam modules may be included for zonal heating and cooling, one per inflatable bladder of the thermoelectric sequential compression device. In other aspects, a single thermoelectric foam module may be included in the thermoelectric sequential compression device for heating or cooling. By independently, and in certain aspects remotely, controlling the temperature and pressure amount of hot air and cold air supplied to any number of inflatable bladders via a user interface, monitoring and operational efficiency of the thermoelectric sequential compression device is improved and achieved in real-time. For example, a blower may be directed to provide any number of inflatable bladders with air in a sequential fashion promoting efficient blood circulation. Unlike conventional compression devices, the thermoelectric sequential compression devices disclosed herein can be integrated with a platform where the subject does not need to sit towards the end of a bed or require a separate overbed table. Because control of the temperature and pressure amount of the hot and cold air is not unrestricted, security and access permissions are particularly customized and implemented via the user interface based on a user type for thermoelectric sequential compression device operation control, including controlled administration of a therapeutic temperature and pressure operation control.

Further aspects of the disclosure are provided by the subject matter of the following clauses.

A thermoelectric sequential compression device, including: a plurality of inflatable bladders arranged in a respective zone of the thermoelectric sequential compression device; a plurality of thermoelectric modules, each of the plurality of thermoelectric modules including a temperature sensor and a foam sheet; and a plurality of channels that are fluidly coupled between the plurality of inflatable bladders and the plurality of thermoelectric modules, wherein a first channel selected from the plurality of channels includes a heat exhaust channel, wherein each of the plurality of thermoelectric modules are independently controlled to sequentially supply air to a respective inflatable bladder of the respective zone via the plurality of channels.

The thermoelectric sequential compression device of the previous clause, wherein each of the plurality of thermoelectric modules are independently controlled by a processor to sequentially supply and maintain hot air and cold air in accordance with respective predetermined threshold values.

The thermoelectric sequential compression device of the previous clause, wherein each of the plurality of thermoelectric modules are independently controlled by a user interface that is communicatively coupled to the processor to sequentially supply and maintain the hot air and cold air in accordance with respective predetermined threshold values.

The thermoelectric sequential compression device of the previous clause, wherein the user interface is configured to restrict temperature control of the hot air and cold air for a first predetermined temperature range by a subject, the first predetermined temperature range including a therapeutic range.

The thermoelectric sequential compression device of the previous clause, wherein the user interface is configured to restrict temperature control of the hot air and cold air for a second predetermined temperature range by a user, the second predetermined temperature range including a temperature range greater than the first predetermined temperature range.

The thermoelectric sequential compression device of any of the previous clauses, wherein a first inflatable bladder is arranged in a first zone, a second inflatable bladder is arranged in a second zone, and a third inflatable bladder is arranged in a third zone, each of the first zone, the second zone, and the third zone are positioned adjacent to leg portions.

The thermoelectric sequential compression device of any of the previous clauses, wherein the thermoelectric sequential compression device is connected to a fan that is configured to exhaust the air from the heat exhaust channel.

The thermoelectric sequential compression device of any of the previous clauses, wherein a first predetermined amount of hot air is supplied at a first temperature value to a first inflatable bladder of a first zone, and a second predetermined amount of cold air is supplied at a second temperature value to a second inflatable bladder of a second zone.

The thermoelectric sequential compression device of any of the previous clauses, wherein the thermoelectric sequential compression device further includes waterproof fabric material that is configured to allow for temperature fluctuation of thermoelectric heating and cooling of the respective inflatable bladder of the respective zone via the plurality of channels.

The thermoelectric sequential compression device of any of the previous clauses, wherein the thermoelectric sequential compression device is connected to a blower that is configured to supply the air to the respective inflatable bladder of the respective zone via the plurality of channels.

The thermoelectric sequential compression device of any of the previous clauses 1-10, wherein the blower includes a stand-alone blower.

The thermoelectric sequential compression device of any of the previous clauses 1-10, wherein the blower is part of a platform.

The thermoelectric sequential compression device of any of the previous clauses, wherein the blower is communicatively coupled to a thermostat that is configured to regulate a temperature of the air supplied to the respective inflatable bladder of the respective zone via the plurality of channels.

The thermoelectric sequential compression device of any of the previous clauses, wherein the foam sheet further includes a first layer and a second layer, the first layer including a lower density than the second layer.

The thermoelectric sequential compression device of any of the previous clauses, wherein the thermoelectric sequential compression device comprises a reusable thermoelectric sequential compression device or a disposable thermoelectric sequential compression device.

The thermoelectric sequential compression device of any of the previous clauses, wherein each of the plurality of thermoelectric modules are independently controlled by a processor that is configured to establish communication with a server.

An integrated bed system, including: a platform including a processor and a non-transitory, processor readable storage medium communicatively coupled to the processor, the non-transitory, processor readable storage medium including one or more instructions stored thereon; and a thermoelectric sequential compression device that is communicatively coupled to the platform, the thermoelectric sequential compression device including: a plurality of inflatable bladders arranged in a respective zone of the thermoelectric sequential compression device; a plurality of thermoelectric modules each including a temperature sensor layer and a foam sheet; and a plurality of channels that are fluidly coupled between the plurality of inflatable bladders and the plurality of thermoelectric modules, wherein a first channel selected from the plurality of channels includes a heat exhaust channel, wherein the one or more instructions, when executed, cause the processor to independently control each of the plurality of thermoelectric modules to sequentially supply air to a respective inflatable bladder of the respective zone via the plurality of channels.

The integrated bed system of the previous clause, wherein the one or more instructions further cause the processor to independently control each of the plurality of thermoelectric modules to sequentially supply and maintain hot air and cold air in accordance with respective predetermined threshold values.

The integrated bed system of the previous clause, the platform further including: a user interface that is communicatively coupled to the processor, wherein the one or more instructions further cause the processor, via the user interface, to sequentially supply and maintain the hot air and the cold air in accordance with respective predetermined threshold values.

The integrated bed system of the previous clause, wherein the one or more instructions further cause the processor, via the user interface, to restrict temperature control of the hot air and the cold air for a first predetermined temperature range by a subject, the first predetermined temperature range including a therapeutic range.

The integrated bed system of the previous clause, wherein the one or more instructions further cause the processor, via the user interface, to restrict temperature control of the hot air and the cold air for a second predetermined temperature range by a user, the second predetermined temperature range including a temperature range greater than the first predetermined temperature range.

The integrated bed system of any of the previous clauses, wherein a first inflatable bladder is arranged in a first zone, a second inflatable bladder is arranged in a second zone, and a third inflatable bladder is arranged in a third zone, each of the first zone, the second zone, and the third zone are positioned adjacent to leg portions.

The integrated bed system of any of the previous clauses, wherein the thermoelectric sequential compression device is connected to a fan that is configured to exhaust the air from the heat exhaust channel.

The integrated bed system of any of the previous clauses, wherein one or more instructions further cause the processor to: direct a blower to supply a first predetermined amount of hot air at a first temperature value to a first inflatable bladder of a first zone, and direct the blower to supply a second predetermined amount of cold air at a second temperature value to a second inflatable bladder of a second zone.

The integrated bed system of any of the previous clauses, wherein the thermoelectric sequential compression device further includes waterproof fabric material that is configured to allow for temperature fluctuation of thermoelectric heating and cooling of the respective inflatable bladder of the respective zone via the plurality of channels.

The integrated bed system of any of the previous clauses, wherein the thermoelectric sequential compression device is connected to a blower that is configured to supply the air to the respective inflatable bladder of the respective zone via the plurality of channels.

The integrated bed system of any of the previous clauses 16-25, wherein the blower includes a stand-alone blower.

The integrated bed system of any of the previous clauses 16-25, the platform further including: a blower that is communicatively coupled to the processor.

The integrated bed system of any of the previous clauses, wherein the blower is communicatively coupled to a thermostat that is configured to regulate a temperature of the air supplied to the respective inflatable bladder of the respective zone via the plurality of channels.

The integrated bed system of any of the previous clauses, wherein the foam sheet further includes a first layer and a second layer, the first layer including a lower density than the second layer.

The integrated bed system of any of the previous clauses, wherein the thermoelectric sequential compression device comprises a reusable thermoelectric sequential compression device or a disposable thermoelectric sequential compression device.

The integrated bed system of any of the previous clauses, wherein the processor is configured to establish communication with a server.

A non-transitory, computer-readable medium including instructions that, when executed by at least one processor, cause the at least one processor to perform one or more operations including: independently controlling each of a plurality of thermoelectric modules of a thermoelectric sequential compression device to sequentially supply air to a respective inflatable bladder of a respective zone of the thermoelectric sequential compression device via a plurality of channels of the thermoelectric sequential compression device, wherein the respective inflatable bladder is one of a plurality of inflatable bladders arranged in the respective zone of the thermoelectric sequential compression device, the plurality of thermoelectric modules each include a temperature sensor and a foam sheet, the plurality of channels are fluidly coupled between the plurality of inflatable bladders and the plurality of thermoelectric modules, and a first channel selected from the plurality of channels includes a heat exhaust channel.

The non-transitory computer-readable medium of the previous clause, the one or more operations further including independently controlling each of the plurality of thermoelectric modules to sequentially supply and maintain hot air and cold air in accordance with respective predetermined threshold values.

The non-transitory computer-readable medium of the previous clause, the one or more operations further including independently controlling, via a user interface, each of the plurality of thermoelectric modules to sequentially supply and maintain the hot air and the cold air in accordance with respective predetermined threshold values.

The non-transitory computer-readable medium of the previous clause, the one or more operations further including restricting temperature control of the hot air and the cold air for a first predetermined temperature range by a subject, the first predetermined temperature range including a therapeutic range.

The non-transitory computer-readable medium of the previous clause, the one or more operations further including restricting temperature control of the hot air and the cold air for a second predetermined temperature range by a user, the second predetermined temperature range including a temperature range greater than the first predetermined temperature range.

The non-transitory computer-readable medium of any of the previous clauses, wherein a first inflatable bladder is arranged in a first zone, a second inflatable bladder is arranged in a second zone, and a third inflatable bladder is arranged in a third zone, each of the first zone, the second zone, and the third zone are positioned adjacent to leg portions.

The non-transitory computer-readable medium of any of the previous clauses, the one or more operations further including controlling a fan to exhaust the air from a heat exhaust channel of the thermoelectric sequential compression device.

The non-transitory computer-readable medium of any of the previous clauses, the one or more operations further including: supplying, by a blower, a first predetermined amount of hot air at a first temperature value to a first inflatable bladder of a first zone, and supplying, by the blower, a second predetermined amount of cold air at a second temperature value to a second inflatable bladder of a second zone.

The non-transitory computer-readable medium of any of the previous clauses, wherein the thermoelectric sequential compression device further including waterproof fabric material that is configured to allow for temperature fluctuation of thermoelectric heating and cooling of the respective inflatable bladder of the respective zone via the plurality of channels.

The non-transitory computer-readable medium of any of the previous clauses, the one or more operations further including supplying, by a blower, to the respective inflatable bladder of the respective zone via the plurality of channels.

The non-transitory computer-readable medium of any of the previous clauses 31-40, wherein the blower includes a stand-alone blower.

The non-transitory computer-readable medium of any of the previous clauses 31-40, wherein the blower is part of a platform.

The non-transitory computer-readable medium of any of the previous clauses, the one or more operations further including controlling a thermostat to regulate a temperature of the air supplied, by a blower, to the respective inflatable bladder of the respective zone via the plurality of channels.

The non-transitory computer-readable medium of any of the previous clauses, wherein the foam sheet further includes a first layer and a second layer, the first layer including a lower density than the second layer.

The non-transitory computer-readable medium of any of the previous clauses, wherein the thermoelectric sequential compression device comprises a reusable thermoelectric sequential compression device or a disposable thermoelectric sequential compression device.

The non-transitory computer-readable medium of any of the previous clauses, wherein the at least one processor is configured to establish communication with a server.

A method, including: independently controlling a thermoelectric module of a thermoelectric sequential compression device to sequentially supply air to a respective inflatable bladder; controlling a blower to supply a first predetermined amount of air at a first predetermined temperature value to a first inflatable bladder, and supply a second predetermined amount of air at a second predetermined temperature value to a second inflatable bladder; controlling a fan to exhaust the air from a heat exhaust channel of the thermoelectric sequential compression device; and restricting, via a user interface, the first and second predetermined temperature values and pressure control of hot air and cold air supplied to the first and second inflatable bladders based on a subject type.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some aspects may be combined in some other aspects. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A thermoelectric sequential compression device, comprising:
a plurality of inflatable bladders arranged in a respective zone of the thermoelectric sequential compression device;
a plurality of thermoelectric modules, each of the plurality of thermoelectric modules comprising a temperature sensor and a foam sheet; and
a plurality of channels that are fluidly coupled between the plurality of inflatable bladders and the plurality of thermoelectric modules, wherein a first channel selected from the plurality of channels comprises a heat exhaust channel,
wherein each of the plurality of thermoelectric modules are independently controlled to sequentially supply air to a respective inflatable bladder of the respective zone via the plurality of channels.

2. The thermoelectric sequential compression device of claim 1, wherein each of the plurality of thermoelectric modules are independently controlled by a processor to sequentially supply and maintain hot air and cold air in accordance with respective predetermined threshold values.

3. The thermoelectric sequential compression device of claim 2, wherein each of the plurality of thermoelectric modules are independently controlled by a user interface that is communicatively coupled to the processor to sequentially supply and maintain the hot air and cold air in accordance with respective predetermined threshold values.

4. The thermoelectric sequential compression device of claim 3, wherein the user interface is configured to restrict temperature control of the hot air and cold air for a first predetermined temperature range by a subject, the first predetermined temperature range comprising a therapeutic range.

5. The thermoelectric sequential compression device of claim 4, wherein the user interface is configured to restrict temperature control of the hot air and cold air for a second predetermined temperature range by a user, the second predetermined temperature range comprising a temperature range greater than the first predetermined temperature range.

6. The thermoelectric sequential compression device of claim 1, wherein a first inflatable bladder is arranged in a first zone, a second inflatable bladder is arranged in a second zone, and a third inflatable bladder is arranged in a third zone, each of the first zone, the second zone, and the third zone are positioned adjacent to leg portions.

7. The thermoelectric sequential compression device of claim 1, wherein the thermoelectric sequential compression device is connected to a fan that is configured to exhaust the air from the heat exhaust channel.

8. The thermoelectric sequential compression device of claim 1, wherein a first predetermined amount of hot air is supplied at a first temperature value to a first inflatable bladder of a first zone, and a second predetermined amount of cold air is supplied at a second temperature value to a second inflatable bladder of a second zone.

9. The thermoelectric sequential compression device of claim 1, wherein the thermoelectric sequential compression device further comprises waterproof fabric material that is configured to allow for temperature fluctuation of thermoelectric heating and cooling of the respective inflatable bladder of the respective zone via the plurality of channels.

10. The thermoelectric sequential compression device of claim 1, wherein the thermoelectric sequential compression device is connected to a blower that is configured to supply the air to the respective inflatable bladder of the respective zone via the plurality of channels.

11. The thermoelectric sequential compression device of claim 1, wherein the blower comprises a stand-alone blower.

12. The thermoelectric sequential compression device of claim 1, wherein the blower is part of a platform.

13. The thermoelectric sequential compression device of claim 1, wherein the blower is communicatively coupled to a thermostat that is configured to regulate a temperature of the air supplied to the respective inflatable bladder of the respective zone via the plurality of channels.

14. The thermoelectric sequential compression device of claim 1, wherein the foam sheet further comprises a first layer and a second layer, the first layer comprising a lower density than the second layer.

15. The thermoelectric sequential compression device of claim 1, wherein the thermoelectric sequential compression device comprises a reusable thermoelectric sequential compression device or a disposable thermoelectric sequential compression device.

16. The thermoelectric sequential compression device of claim 1, wherein each of the plurality of thermoelectric modules are independently controlled by a processor that is configured to establish communication with a server.

17. An integrated bed system, comprising:
a platform including a processor and a non-transitory, processor readable storage medium communicatively coupled to the processor, the non-transitory, processor readable storage medium comprising one or more instructions stored thereon; and
a thermoelectric sequential compression device that is communicatively coupled to the platform, the thermoelectric sequential compression device comprising:
a plurality of inflatable bladders arranged in a respective zone of the thermoelectric sequential compression device;
a plurality of thermoelectric modules each comprising a temperature sensor layer and a foam sheet; and
a plurality of channels that are fluidly coupled between the plurality of inflatable bladders and the plurality of thermoelectric modules, wherein a first channel selected from the plurality of channels comprises a heat exhaust channel,
wherein the one or more instructions, when executed, cause the processor to independently control each of the plurality of thermoelectric modules to sequentially supply air to a respective inflatable bladder of the respective zone via the plurality of channels.

18. The integrated bed system of claim 17, wherein the one or more instructions further cause the processor to independently control each of the plurality of thermoelectric modules to sequentially supply and maintain hot air and cold air in accordance with respective predetermined threshold values.

19. The integrated bed system of claim 18, the platform further comprising:
a user interface that is communicatively coupled to the processor, wherein the one or more instructions further cause the processor, via the user interface, to sequentially supply and maintain the hot air and the cold air in accordance with respective predetermined threshold values.

20. The integrated bed system of claim 19, wherein the one or more instructions further cause the processor, via the user interface, to restrict temperature control of the hot air and the cold air for a first predetermined temperature range by a subject, the first predetermined temperature range comprising a therapeutic range.
